(19) United States
(12) Patent Application Publication
(10) Pub. No.: US 2014/0131547 A1
(43) Pub. Date: May 15, 2014

(54) HIGH-DAMPING DEVICE

(71) Applicant: Hong-I TSAI, Taipei City (TW)

(72) Inventor: Hong-I TSAI, Taipei City (TW)

(21) Appl. No.: 13/673,593

(22) Filed: Nov. 9, 2012

(51) Int. Cl. F16M 11/02

(52) U.S. Cl. CPC F16M 11/02
USPC 248/636

(57) ABSTRACT

A high-damping device includes a stiffness platform, a damping unit, and a joining medium layer. The stiffness platform has a basin. The damping unit has a concrete base received in the basin of the stiffness platform. The joining medium layer is an adhesive layer coated on a bottom and a sidewall of the basin of the stiffness platform. The high-damping device may support a machine weights several tons and provide a good dynamic stiffness.

### BACKGROUND OF THE INVENTION

1. Field of the Invention

The present invention relates generally to a shock absorber, and more particular to a high-damping device.

2. Description of the Related Art

In the field of high precision manufacturing industry, such as the wafer manufacturing, it has to control many factors in the FAB, such as temperature, humidity and dust-free, to ensure the quality of the products. Vibration is another import factor that affects the quality. Vibration may come from the machine itself or earthquake. A damping device is provided to obtain a high dynamic stiffness between the machine and ground. However, some machines are very heavy, maybe tons, and the conventional damping devices, such as spring or hydraulic systems, are insufficient to support them.

### SUMMARY OF THE INVENTION

The primary objective of the present invention is to provide a high-damping device, which may firmly support a heavy machine to provide a high dynamic stiffness.

According to the objective of the present invention, the present invention provides a high-damping device, including a stiffness platform, a damping unit, and a joining medium layer. The stiffness platform has a basin, which is open at a top thereof and has a bottom and an annular sidewall. The damping unit has a concrete base received in the basin of the stiffness platform. The concrete base is made by filling the basin of the stiffness platform with concrete slurry and hardening the concrete slurry. The joining medium layer is set between the stiffness platform and the damping unit, and is made by coating an adhesive on the sidewall and the bottom of the basin.

Therefore, the damping may provide a good ability to resist dynamic displacement to reduce the effect of vibration.

### BRIEF DESCRIPTION OF THE DRAWINGS

FIG. 1 is a sectional view of a first preferred embodiment of the present invention; and

FIG. 2 is a sectional view of a second preferred embodiment of the present invention.

### DETAILED DESCRIPTION OF THE INVENTION

The detailed description and technical contents of the present invention will be explained with reference to the accompanying drawings. However, the drawings are for illustration only and cannot be used to limit the present invention.

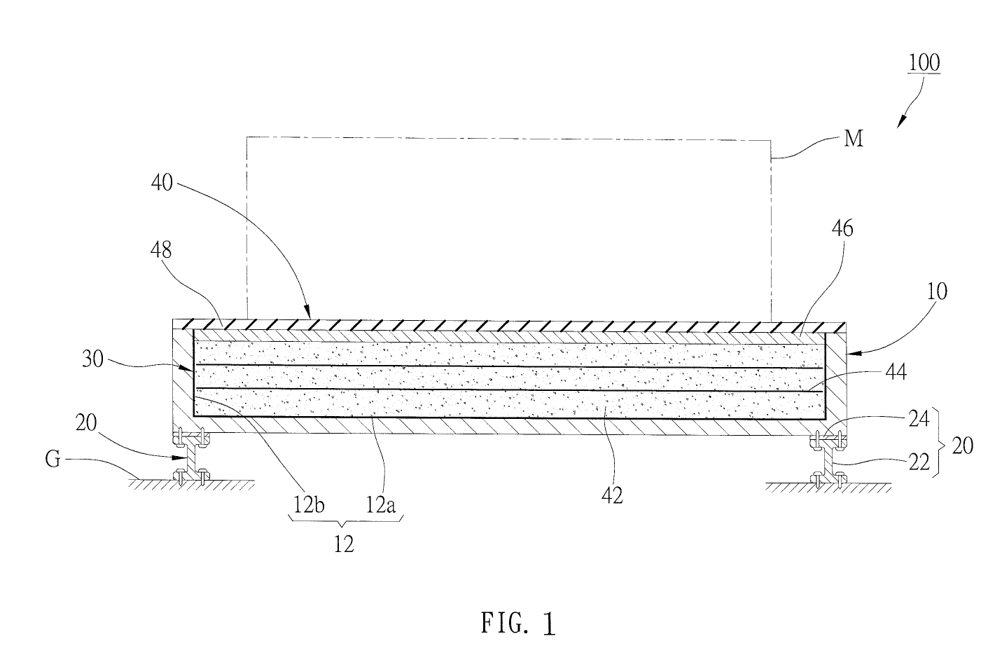

As shown in FIG. 1, a high-damping device 100 of the first preferred embodiment of the present invention, which may support a machine M weighting several tons and provide a good dynamic stiffness, includes a stiffness platform 10, a support member 20, a joining medium layer 30, and a damping unit 40.

The stiffness platform 10 is made by steel and has a basin 12. The basin 12 is open at a top thereof and has a bottom 12a and an annular sidewall 12b.

The support member 20 connects to a bottom of the stiffness platform 10 with an end, and affixes to the ground G with the other end. In an embodiment, the support member 20 has several H-beams 22 and pads 24. The two ends of the each H-beams 22 are respectively affixed to the bottom of the stiffness platform 10 and the ground G by welding or bolting. The pads 24 are made of rubber and are mounted between the stiffness platform 10 and the H-beams 22. The number of the pads 24 and the places where the pads 24 are mounted are subject to change. The support member 20 lifts the machine M off the ground G.

The joining medium layer 30 is made by coating an adhesive on the bottom 12a and the sidewall 12b of the basin 12. The adhesive may be epoxy, polyethylene (PE), or other equivalent materials.

The damping unit 40 is received in the basin 12 of the stiffness platform 10. In an embodiment, the damping unit 40 has a concrete base 42, a plurality of steel wire nets 44, a reinforced fiber layer 46, and a damping surface material 48. In an embodiment, the concrete base 42 is made by filling the basin 12 of the stiffness platform 10 with concrete slurry and waiting for hardening. The concrete is mixed with a anti-shrinkage additive, such as air-entraining agent, to completely eliminate the defect (shrinkage cracks) in the concrete base 42. The steel wire nets 44 are embedded in the concrete base 42 in a predetermined layout to increase the strength of the concrete base 42. The reinforced fiber layer 46 is attached to a top of the concrete base 42 to keep moisture and to provide the concrete base 42 a smooth surface. The damping surface material 48 is attached to the reinforced fiber layer 46. In an embodiment, the damping surface material 48 is an epoxy sheet to provide the concrete base 42 a smooth surface on which the machine M is firmly mounted.

The concrete base 42 may support the machine M which weighs several tons, and furthermore it may resist the dynamic displacement while there is a repeated fluctuating load effect between the machine M and the ground G. In other words, the high-damping device 100 has a good dynamic stiffness to reduce the effect of vibration. In addition, between the stiffness platform 10 and the damping unit 40 is the joining medium layer 30 that may avoid the increase of a gap between the concrete base 42 and the sidewall of the basin 12 to firm up the entire high-damping device 100. The gap appears because of the heat generated from the chemical reaction between water and concrete while hardening the concrete (so called “heat of hydration”). It will make the temperature of the concrete increase, and the gap will appear when the stress or strain caused by the temperature difference is greater than the tensile strength or tensile strain of the concrete. The joining medium layer 30 may avoid such gap from increasing.

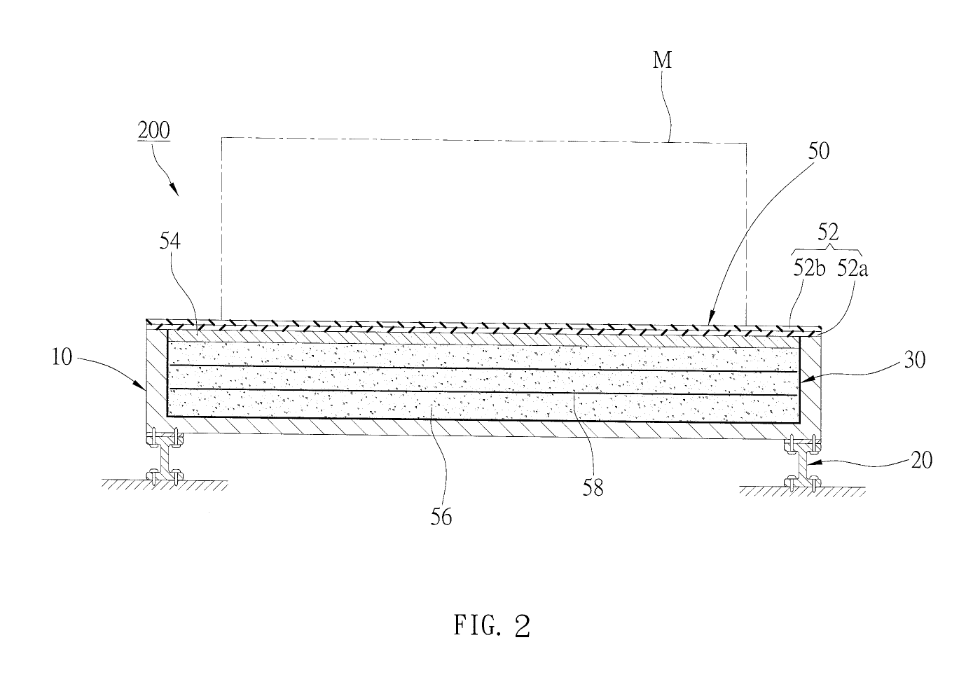

FIG. 2 shows a high-damping device 200 of the second preferred embodiment of the present invention, which is similar to the first preferred embodiment, including the stiffness platform 10, a support member 20, and a joining medium layer 30. The different part is that a damping surface material 52 of a damping unit 50 has an adhesive layer 52a and an epoxy sheet 52b. The adhesive layer 52a is made of polyamide or silicon material to be attached to a reinforced fiber layer 54. The epoxy sheet 52b is attached to the other side of the adhesive layer 52a to provide a smooth surface for setting the machine M. The damping unit 50 still has a concrete base 56, a plurality of steel wire nets 58, and the reinforced fiber layer 54, and they are the same as the first preferred embodiment, so we do not describe the detail again. The high-damping device 200 of the second preferred embodiment provides a good dynamic stiffness as well.

The description above is a few preferred embodiments of the present invention. The equivalence of the present invention is still in the scope of claim construction of the present invention.

What is claimed is:

1. A high-damping device, comprising:
a stiffness platform having a basin, wherein the basin is open at a top thereof and has a bottom and an annular sidewall;
a damping unit having a concrete base received in the basin of the stiffness platform, wherein the concrete base is made by filling the basin of the stiffness platform with concrete slurry and hardening the concrete slurry; and
a joining medium layer between the stiffness platform and the damping unit, wherein the joining medium layer is made by coating an adhesive on the sidewall and the bottom of the basin.

2. The high-damping device as defined in claim 1, wherein the adhesive of the joining medium layer is made of epoxy.

3. The high-damping device as defined in claim 1, wherein the adhesive of the joining medium layer is made of polyethylene.

4. The high-damping device as defined in claim 1, wherein the damping unit further includes a reinforced fiber layer attached to a top of the concrete base.

5. The high-damping device as defined in claim 4, wherein the damping unit further includes a damping surface material attached to the reinforced fiber layer.

6. The high-damping device as defined in claim 5, wherein the damping surface material is made of epoxy.

7. The high-damping device as defined in claim 5, wherein the damping surface material includes an adhesive layer attached to the reinforced fiber layer and an epoxy sheet attached to the adhesive layer.

8. The high-damping device as defined in claim 7, wherein the adhesive layer is made of a polyamide material or a silicon material.

9. The high-damping device as defined in claim 1, further comprising a support member respectively affixed to a bottom of the stiffness platform and ground respectively.

10. The high-damping device as defined in claim 9, wherein the support member has a plurality of H-beams and pads, and the H-beams have opposite sides respectively affixed to the bottom of the stiffness platform and the ground, and the pads are respectively placed between the H-beams and the stiffness platform respectively.

11. The high-damping device as defined in claim 1, wherein the damping unit further includes at least a steel wire net embedded in the concrete base.

12. The high-damping device as defined in claim 1, wherein the concrete is mixed with a anti-shrinkage additive to reduce shrinkage cracks in the concrete base.

13. The high-damping device as defined in claim 1, wherein the anti-shrinkage additive is an air-entraining agent.

14. The high-damping device as defined in claim 1, further comprising a support member respectively affixed to a bottom of the stiffness platform and ground respectively, wherein the damping unit further includes a reinforced fiber layer attached to a top of the concrete base, a damping surface material attached to the reinforced fiber layer and at least a steel wire net embedded in the concrete base, and the concrete is mixed with a anti-shrinkage additive.
